(19) United States
(12) Patent Application Publication
(10) Pub. No.: US 2005/0183268 A1
(43) Pub. Date: Aug. 25, 2005

(54) Folding knife assembly with positionable blade

(75) Inventor: Shun-Fu Chen, Lujhou City (TW)

Correspondence Address: BACON & THOMAS, PLLC, 625 SLATERS LANE, FOURTH FLOOR, ALEXANDRIA, VA, 22314, US

(73) Assignee: JAR YUI ENTERPRISE CO., LTD., Taipei Hsien (TW)

(21) Appl. No.: 10/979,163

(22) Filed: Nov. 3, 2004

(30) Foreign Application Priority Data
Feb. 20, 2004 (TW) 093104238

(51) Int. Cl. B26B 1/02

(52) U.S. Cl. 30/161

(57) ABSTRACT

The present invention discloses a folding knife assembly allows its blade to be positioned therein, such that when the blade of the folding knife is stored in an accommodating space of a handle, a latch member on the handle is used to fix the blade in the accommodating space and prevent the blade from rotating out from the accommodating space by accident and causing a stabbed wound or an incised wound to the user or others.

### FIELD OF THE INVENTION

The present invention relates to a folding knife assembly, more particularly to a folding knife assembly that allows its blade to be positioned therein.

### BACKGROUND OF THE INVENTION

In general, a traditional folding knife comprises a handle and a blade; wherein the blade has a pivotal connecting section at one end and the pivotal connecting section is pivotally coupled with the handle, such that the blade can be stored in an accommodating space disposed on one side of the handle. Therefore, when a user wants to use the folding knife, the user holds the handle by one hand and pulls the blade jointly by the index finger and the thumb of the other hand, so that the blade can be pulled out from the accommodating space of the handle. However, such folding knife has the following shortcomings. Firstly, the pivotal connection between the blade and the handle will become loosened after the folding knife has been used for some time, and thus the blade usually will rotate out from the accommodating space when the folding life is shaken or hit by external forces. Secondly, when a user wants to use the folding knife, the user has to use both hands to take the blade out from the handle, and thus if the user encounters a special occasion that there is only one hand available, the user may not be able to use the folding knife. For example, the special occasion include the situation of a user's hand being tangled by the string of a net and needing to use the knife to cut the string immediately to save one's life, or one of the user's hands is injured while the uninjured hand is available, or even for a user who has lost one of his hands.

Please refer to FIG. 1 for a “sling blade” developed and sold in the market for overcoming the foregoing shortcomings. The sling blade 5 comprises a hollow handle 50, an accommodating space disposed on one side of the handle 50 for storing a blade 51, one end of the blade point 511 and the other end being a pivotal connecting section 512, wherein the pivotal connecting section 512 is pivotally coupled to an axial rod 52 at one end of the handle 50, and a resilient member 53 connected to the blade 51 is disposed in the handle 50, and a press switch 54 protruded from the surface of the handle 50 for latching the blade 51 is disposed in the handle 50 on the other side of the blade 51 at a position proximate to the axial rod 52, such that when a user presses the press switch 54, the press switch 54 releases the latch of the blade 51, and the blade 51 rotates about the axis of the axial rod 52 by the resilience of the resilient member 53 and quickly extends out of the handle 50. In other words, the user only needs to use one hand to operate the sling blade 5 quickly and easily. Further, the pivotal connection of the sling blade 5 between the blade 51 and the handle 50 will not be loosened easily due to its frequent use. However, the press switch 54 is protruded from an obvious position on the surface of the handle 50, which may be pressed by accident or played by children as to release the blade 51 and cause a risk of being cut. The original intention of the design has turned into a danger to the user.

Please refer to FIG. 2 for another folding knife structure, which comprises a handle 60, an accommodating space disposed on one side of the handle 60, a blade 61 pivotally coupled to one end of the handle 60, such that the blade 61 can be rotated into the accommodating space or rotated out from the accommodating space. Further, a poking rod 62 is protruded from a position of exposing the blade 61 on both sides outside the accommodating space, and a brake member 7 is disposed at one side of the blade 61 proximate to the position where the handle 60 and the blade 61 are pivotally coupled with each other, and an indentation 70 is disposed on the brake member 7. Further, a resilient strip 8 is disposed in the accommodating space, and one end of the resilient strip 8 is extended to a position proximate to the brake member 7, so that when the blade 61 is folded into the accommodating space, the circumference of the maximum external diameter of the brake member 7 will press the resilient strip 8, and the resilient strip 8 will be deformed to store a resilient force. Therefore, when the blade 61 is folded into the accommodating space, a user can use one hand to hold the handle 60, and use a thumb and an index finger to push the poking rod 62 as to cause the brake member to start rotating and progressively release the pressing condition of the resilient strip 8 until the resilient strip 8 is extended into the indentation 70. Since the resilience produced by the deformation of the resilient strip 8 will be acted on the indentation 70 of the brake member 7, therefore the brake member starts producing a torque to rotate the blade 61 towards the accommodating space, so that the blade can be extended out from the handle 60 quickly. In other words, a user only needs to push the poking rod 62 by the fingers of one hand to quickly rotate the blade 61 out from the handle 60. However, some users put the folding knife in their pocket, the poking rod 62 may be pushed by accident due to external forces and rotated out from the handle 60, which may results an accident of an incised wound or stabbed wound.

In summation of the foregoing description, since various articles and quality goods of daily use are introduced at every moment, people not only ask for a friendly design on the appearance and overall design of the knife structure, but also requests powerful functions and convenient operations. On the other hand, people usually neglect the safety of the knife itself. Therefore, the way of designing a stylish, friendly, functional and safe knife becomes a key factor for improving the market share and an important subject that demands immediate attention. Such design can meet the low-cost, highly efficient and effective requirements of the current industry.

### SUMMARY OF THE INVENTION

In view of the aforementioned shortcomings of the prior-art knife and the trend of knife design, more emphases are placed on the safety of the knife in addition to the stylish appearance. Therefore, the inventor of the present invention based on years of experience in the related industry conducted extensive researches and experiments and finally invented a folding knife assembly in accordance with the present invention.

The primary objective of the present invention is to provide a folding knife assembly, such that when the blade of the knife is stored in the accommodating space, a latch member on the handle is used to fix the blade in the accommodating space and prevent the blade from rotating out from the accommodating space by accident and causing a stabbed wound or an incised wound to the user or others.

The above and other objects, features and advantages of the present invention will become apparent from the following detailed description taken with the accompanying drawings.

### BRIEF DESCRIPTION OF THE DRAWINGS

FIG. 1 is an exploded view of a prior-art sling blade.

FIG. 2 is an illustrative view of a prior-art folding knife.

FIG. 3 is a perspective view of the present invention.

FIG. 4 is an exploded view of the present invention.

FIG. 5A is an illustrative view of the present invention.

FIG. 5B is another illustrative view of the present invention.

FIG. 6 is a cross-sectional view of the present invention.

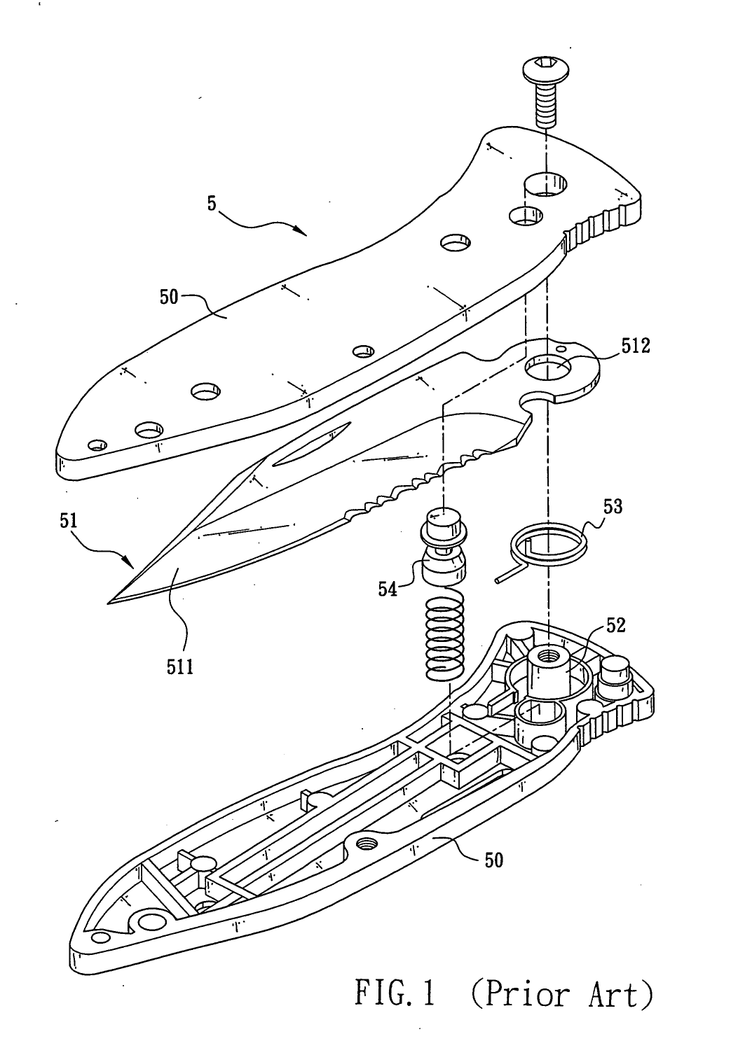

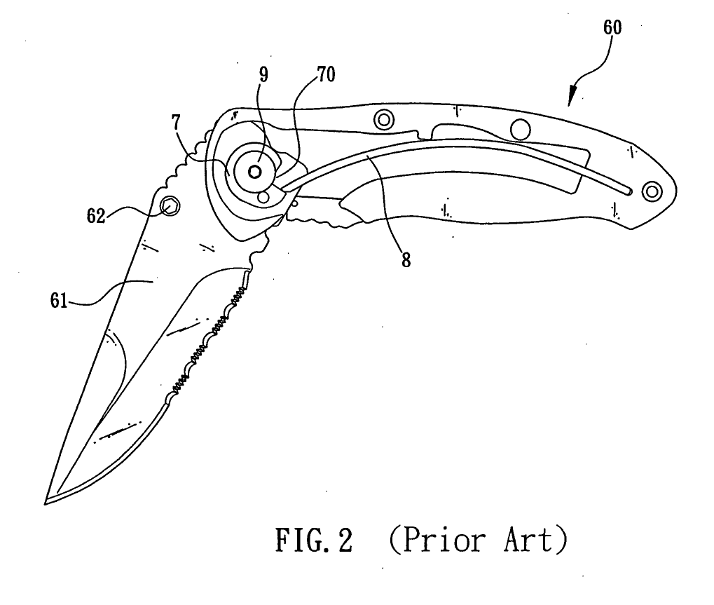

### DETAILED DESCRIPTION OF THE PREFERRED EMBODIMENTS

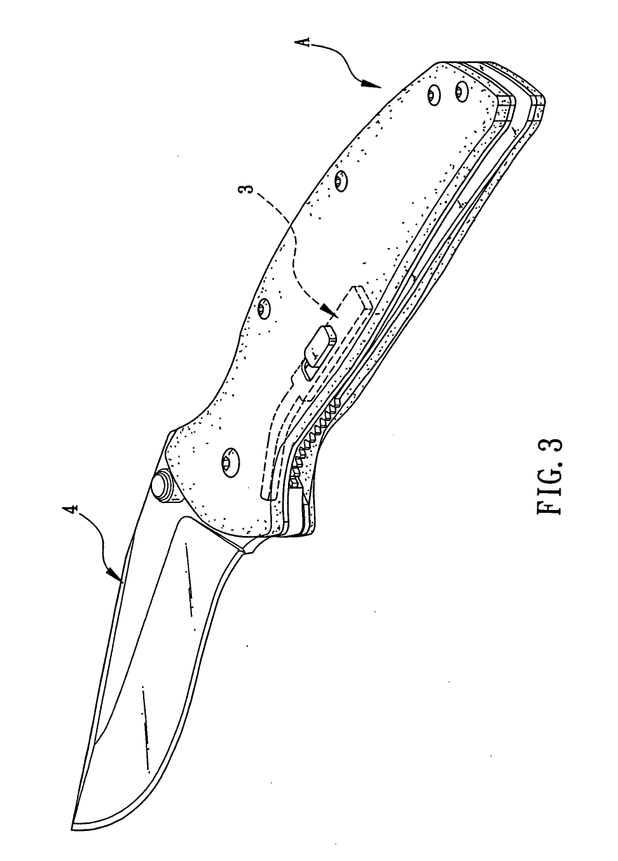

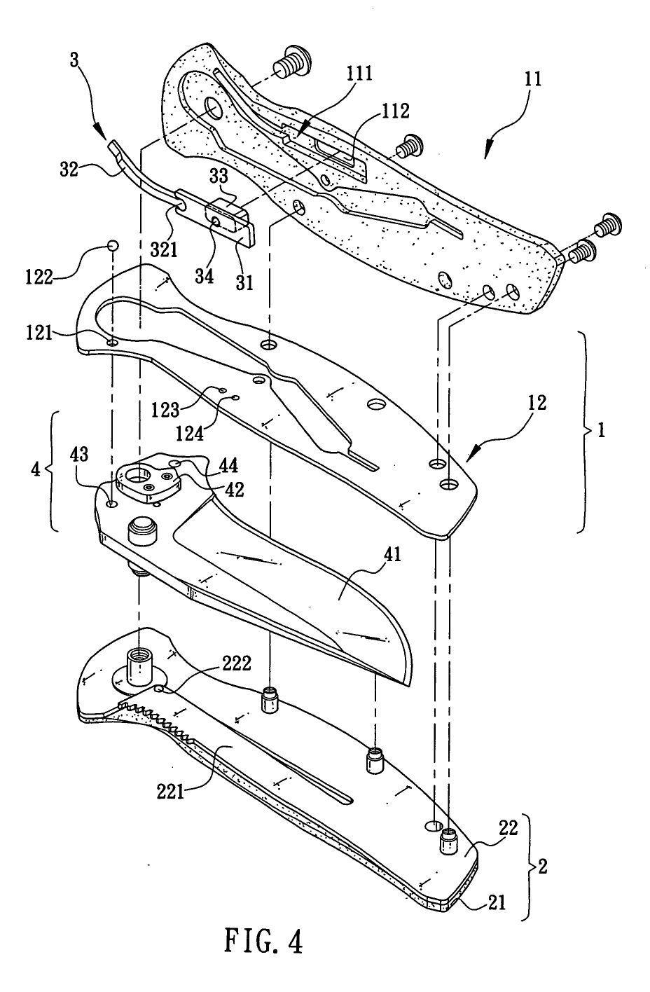

Please refer to FIGS. 3 and 4 for the folding knife assembly that can fix a blade into place. The folding knife comprises a first half handle 1, a second half handle 2, a latch member 3 and a blade 4, wherein the first half handle 1 further comprises a chassis 11 and an internal plate 12 both having a similar shape and being flatly attached as a whole, a sliding groove 111 disposed on the internal surface of the chassis 11, a penetrating hole 112 disposed in the sliding groove 111 and interconnected to the external surface of the chassis 11, a first circular aperture 121 disposed on the internal plate 12 and a bead 122 embedded in the first circular aperture 121. The latch member 3 comprises a pushing section 31, a latch strip 32 and a push button 33, and one end of the pushing section 31 is coupled to one end of the latch strip 32, and the push button 33 is protruded from one side of the pushing section 31, such that the latch member 3 is disposed between the chassis 11 and the internal plate 12. When the latch member 3 is installed in the sliding groove 111, the push button 33 is exposed from the penetrating hole 112 on the surface of the chassis 11. The second half handle 2 comprises another chassis 21 and another internal plate 22 being flatly attached as a whole, and the second half handle 2 is coupled to the first half handle 1 to form a handle A, and define an accommodating space with a common side. The blade 4 comprises a knife point 41 on one end and a pivotal connecting section 42 on the other end. The pivotal connecting section 42 is pivotally clamped between the first half handle 1 and the second half handle 2 on a common end, such that the blade 4 can be rotated into or out from the accommodating space. A second circular aperture 43 is disposed on the blade 4 proximate to the pivotal connecting section 42 and at a position corresponding to the latch strip 32.

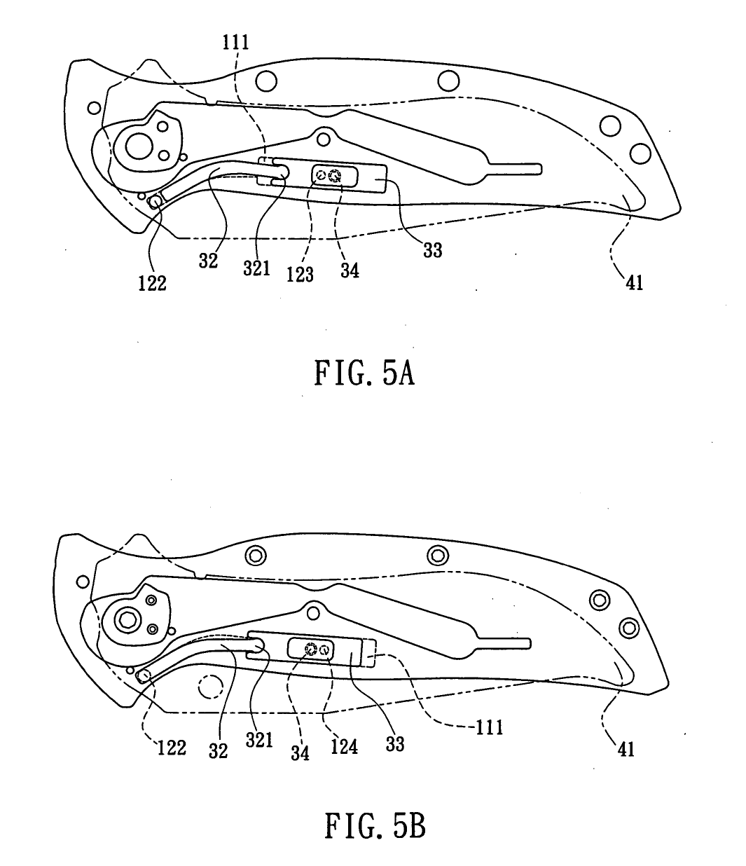

With the foregoing perfect design and assembly, when the blade 4 is rotated and stored in the accommodating space, the push button 33 is pushed towards the pivotal connecting section 42, so that the latch strip 32 produces a movement and presses the first bead 122. Since the first bead 122 is pressed, some part of the volume of the first bead 122 is protruded from the first circular aperture 121 and the first bead 122 falls into the second circular aperture 43 (as shown in FIG. 5B). Thus, such arrangement can achieve the effect of fixing the blade 4 into the accommodating space to prevent the blade 4 from being rotated out or popped out from the accommodating space by mistake and prevent accidence. On the other hand, the push button 33 is pushed away from the pivotal connecting section 42 (as shown in FIG. 5A) the latch strip 32 releases the pressure produced on the first bead 122. Therefore, if the blade 4 is rotated out from the accommodating space, the second circular aperture 43 is moved away from the first bead 122, such that the first bead 122 is pushed by the surface of the blade 4 to fall into the first circular aperture 121 again.

Please refer to FIG. 4 for a preferred embodiment of the present invention. A third circular aperture 44 is disposed on the blade 4 proximate to the pivotal connecting section 42 and corresponding to one side of the second circular aperture 43, such that the blade 4 is rotated completely out from the accommodating space, and the push button 33 is pushed towards the knife point 41. As a result, the latch strip 32 presses the first bead 122, so that the first bead 122 has some part of its volume protruded from the first circular aperture 121 and the first bead 122 falls into the third circular aperture 44 to achieve the effect of fixing the blade 4 into place and prevent the blade 4 from rotating into the accommodating space when the folding knife is in use.

Please refer to FIG. 4 for another preferred embodiment of the present invention. The latch member 3 comprises a pushing section 31, a latch strip 32 and a push button 33, wherein the pushing section 31 comprises a second bead 34 embedded on a side facing the internal plate 12, and a fourth circular aperture 123 and a fifth circular aperture 124 are disposed on the corresponding positions of the internal plate 12 and the second circular bead 34, so that when the blade 4 is stored into the accommodating space, the push button 33 is pushed toward the pivotal connecting section (as shown in FIG. 5A), and the second bead 34 precisely falls into the fourth circular aperture 123. When the push button 33 is pushed away from the pivotal connecting section 42, the second bead 34 precisely falls into the fifth circular aperture 124. With the foregoing ingenious design, an obvious sectional feel is produced when the push button 33 is pushed, and the effects of fixing the blade 4 and the pushing section 31 can be achieved.

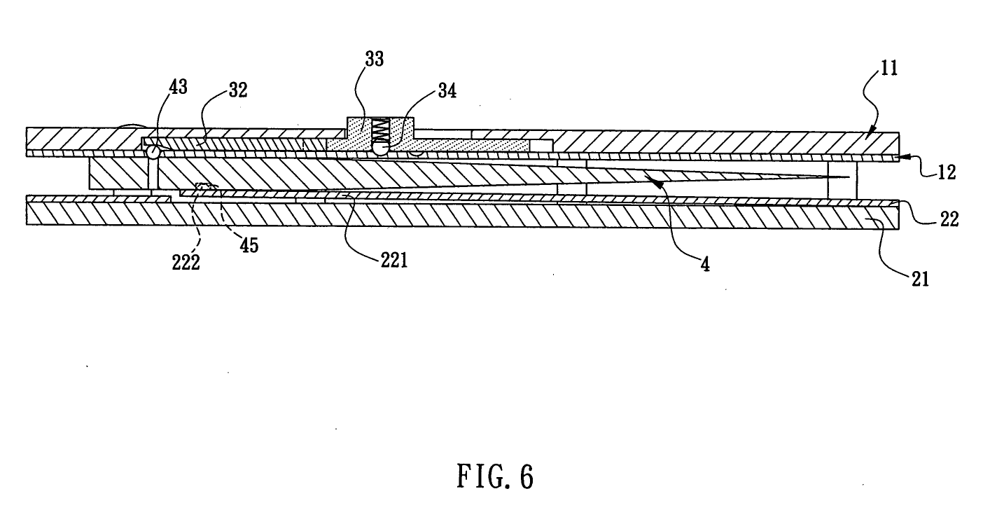

Please refer to FIG. 4 for a further preferred embodiment of the present invention. Another internal plate 22 comprises a bracket 221 slightly curved towards the blade 4, such that when the blade 4 is stored into the accommodating space, the surface of the blade 4 presses the bracket 221 to produce a deformation. When the blade 4 is rotated out from the accommodating space, the bracket 221 recovers its original slightly curved condition by the resilience, so that the end of the bracket 221 presses precisely on the bottom edge of the blade 4. Such ingenious arrangement can improve the stability of the blade 4 being mounted on the handle A, so that when a user operates the folding knife, the user's fingers will not be cut by a sudden rotation of the blade 4. On the other hand, when the bracket 221 is pressed to produce a deformation, the bottom edge of the blade 4 is separated from the bracket 221, and thus the blade 4 can be rotated into the accommodating space and maintains a mutual pressing condition with the bracket 221 again. Further, the bracket 221 could further include a third bead 222, and the blade 4 could include a sixth circular aperture 45 (as shown in FIG. 6), such that when the blade 4 is rotated into the accommodating space and contacted with the bracket 221, some part of the volume of the third circular bead 222 is disposed precisely in the sixth circular aperture 45 as to achieve the effect of fixing the blade 4 into the accommodating space.

In the foregoing preferred embodiments, if the sliding groove 111 is not designed in a straight line, it will be unfavorable for the pushing section 31 to be pushed in the sliding groove 111. Therefore, a circular indentation is set at the center of one end of the pushing section 31, and a sphere 321 is disposed at one end of the latch strip 32, wherein the sphere 321 is installed precisely in the circular indentation to form a joint-like pivotal structure. With such design, the pushing section 31 and the latch strip 32 will not be restricted by the shape and the traveling direction in the accommodating space when being pushed in the sliding groove 111.

While the invention has been described by means of specific embodiments, numerous modifications and variations could be made thereto by those skilled in the art without departing from the scope and spirit of the invention set forth in the claims.

1. A folding assembly with positionable blade, comprising:
a first handle, including a chassis and an internal plate flatly attached with each other as a whole, and said chassis having a sliding groove disposed on the surface of said chassis, and said sliding groove having a penetrating hole interconnected to the external surface of said chassis, a circular aperture disposed on said internal plate, and a first bead embedded into said first circular aperture;
a latch member, including a pushing section, a latch strip and a push button, and one end of said pushing section being coupled to one end of said latch member and said push button being protruded on one side of said pushing section, such that said latch member being disposed between said chassis and said internal plate and said push button being exposed from the external surface of said chassis when being installed in said sliding groove;
a second half handle, including another chassis and another internal plate, being flatly attached with each other as a whole, and said second handle being coupled with said first half handle to form a handle and define an accommodating space on one side of said handle;
a blade, having one end being a knife point and the other end being a pivotal connecting section, and said pivotal connecting section being clamped and pivotally coupled between said first handle and an end of said second handle, thereby said blade being rotated selectively into and out from said accommodating space, and a second circular aperture being disposed on said blade at a position proximate to said pivotal connecting section and corresponding to said latch strip, such that when said blade being stored into said accommodating space, said push button being pushed towards said pivotal connecting section and said latch strip producing a movement to push said first bead, thereby some part of the volume of said first bead being protruded from said first bead and falling into said second circular aperture as to fix said blade into said accommodating space.

2. The folding assembly with positionable blade of claim 1, wherein said blade comprises a third circular aperture being proximate to said pivotal connecting section and corresponding one said of said second circular aperture, thereby when said blade is rotated completely out from said accommodating space and said push button is pushed towards said pivotal connecting section, said latch strip presses precisely on said first bead to exposed some part of the volume of said first bead out from said first circular aperture, and lets said first bead fall into said third circular aperture to fix said blade.

3. The folding assembly with positionable blade of claims 1, wherein said pushing section comprises a second bead embedded into a surface facing said internal plate and a fourth circular aperture disposed on said internal plate at a position corresponding said second bead, such that when said push button is pushed towards said pivotal connecting section, some part of the volume of said second bead falls precisely into said fourth circular aperture.

4. The folding assembly with positionable blade of claims 2, wherein said pushing section comprises a second bead embedded into a surface facing said internal plate and a fourth circular aperture disposed on said internal plate at a position corresponding said second bead, such that when said push button is pushed towards said pivotal connecting section, some part of the volume of said second bead falls precisely into said fourth circular aperture.

5. The folding assembly with positionable blade of claim 3, wherein said internal plate comprises a fifth circular aperture at a position corresponding to said second bead and proximate said fourth circular aperture, such that when said push button is pushed towards said pivotal connecting section, some part of the volume of said second bead falls precisely into said fifth circular aperture.

6. The folding assembly with positionable blade of claim 4, wherein said internal plate comprises a fifth circular aperture at a position corresponding to said second bead and proximate said fourth circular aperture, such that when said push button is pushed towards said pivotal connecting section, some part of the volume of said second bead falls precisely into said fifth circular aperture

7. The folding assembly with positionable blade of claim 1, wherein said another internal plate comprises a bracket slightly curved towards said blade, such that when said blade is stored into said accommodating space, the surface of said blade presses said bracket to produce a deformation, and when said blade is rotated out from said accommodating space, said bracket recovers its original slightly curved condition by a resilience of said bracket and the end of said bracket presses against the bottom edge of said blade.

8. The folding assembly with positionable blade of claim 1, wherein said bracket comprises a third bead and said blade comprise a sixth circular aperture, such that when said blade is rotated into said accommodating space and contacted with said bracket, some part of the volume of said third bead is disposed precisely in said sixth circular aperture.

9. The folding assembly with positionable blade of claim 1, wherein said pushing section at the center of one end comprises a circular indentation, and said latch strip at one end comprises a sphere, and said sphere is installed precisely in said circular indentation to form a joint-like pivotal connecting structure.
